(19) United States
(12) Patent Application Publication
(10) Pub. No.: US 2008/0016539 A1
(43) Pub. Date: Jan. 17, 2008

(54) Display service method, network device capable of performing the method, and storage medium storing the method

(75) Inventor: Kee-wook Na, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/606,141

(22) Filed: Nov. 30, 2006

(30) Foreign Application Priority Data
Jul. 13, 2006 (KR) 10-2006-0065901

(51) Int. Cl. H04N 7/173

(52) U.S. Cl. 725/105

(57) ABSTRACT

Provided are a display service method for automatically displaying the same screen image on a plurality of network devices at the same time based on pre-set schedule information in a network based on a plurality of network devices, a network device capable of performing the method, and a storage medium thereof. The method includes capturing a screen image of a first network device based on pre-set schedule information, and transmitting the captured screen image to at least one second network device. Accordingly, screen images displayed on a network device can be displayed on different network devices regardless of a format of the screen images.

### CROSS-REFERENCE TO RELATED PATENT APPLICATION

This application claims the benefit of priority from Korean Patent Application No. 10-2006-0065901, filed on Jul. 13, 2006, in the Korean Intellectual Property Office, the disclosure of which is incorporated herein in its entirety by reference.

### BACKGROUND OF THE INVENTION

1. Field of the Invention

The present invention relates to a display service in a network based on a plurality of network devices, and more particularly, to a display service method for displaying a screen image of a network device on another network device, a network device capable of performing the method, and a storage medium storing the method.

2. Description of the Related Art

Network devices are devices having at least a display function and may include consumer electronic (CE) devices such as camcorders, digital televisions (DTVs), desktop computers, and display devices. Thus, a network device can be defined as a network display device. In addition, a network device can be a device having an additional function capable of storing and reproducing at least one of music content files, still image content files, moving picture content files, and composite content files in which music content and image content are mixed.

According to the prior art, in order to perform a display service for displaying a screen image of a network device on at least one different network device in a network including at least two network devices (or a plurality of network devices), an application program for displaying the screen image must be installed in the different network device.

For example, if it is assumed that one network device is a personal computer (PC) and another network device is a display device placed in a meeting room, in order to view a document edited on the PC using PowerPoint on the display device, an application program for displaying the document edited using PowerPoint must be installed in the display device.

To solve this problem, a technique of displaying a screen image that is being displayed on a PC on another display device by introducing a thin-client concept has been disclosed. However, according to this technique, a desired screen image can be displayed on the display device only if a user directly performs real-time control using a keyboard or mouse connected to the PC.

In addition, according to the conventional display service, it is impossible to transmit the same screen image to a plurality of display devices at the same time, and it is impossible to transmit a currently displayed screen image for a desired duration by specifying a predetermined time or only a screen image of a specific program.

### SUMMARY OF EXEMPLARY EMBODIMENTS OF THE INVENTION

Exemplary embodiments of the present invention provide a display service method for automatically displaying the same screen image on a plurality of network devices at the same time based on pre-set schedule information in a network based on a plurality of network devices, a network device capable of performing the method, and a storage medium thereof.

Exemplary embodiments of the present invention also provide a display service method for automatically splitting a screen image that is being displayed on a network device, and displaying the split screen images on at least two network devices based on pre-set schedule information in a network based on a plurality of network devices, a network device capable of performing the method, and a storage medium thereof.

Exemplary embodiments of the present invention also provide a display service method for outputting a screen image that is being displayed on a network device, and at least one content file that is stored in the network device, to at least one different network device based on pre-set schedule information in a network based on a plurality of network devices, a network device capable of performing the method, and a storage medium thereof.

The present invention also provides a display service method for simultaneously displaying the entire or a portion of a screen image that is being displayed on a network device, or a screen image of a specific program that is being executed in the network device, on at least one different network device based on pre-set schedule information in a network based on a plurality of network devices, a network device capable of performing the method, and a storage medium thereof.

According to an aspect of the present invention, there is provided a display service method in a network based on a plurality of network devices, the method comprising: capturing a screen image of a first network device based on pre-set schedule information; and transmitting the captured screen image to at least one second network device.

The method may further comprise transmitting at least one content file stored in the first network device based on the schedule information.

If the number of second network devices is N, the capturing of the screen image may comprise capturing N screen images, and the transmitting of the captured screen image may comprise respectively transmitting the captured N screen images to the N second network devices.

According to another aspect of the present invention, there is provided a network device capable of providing a display service between network devices, the network device comprising: a display unit displaying a screen image; a scheduler managing a schedule for the display service based on pre-set schedule information; a screen capture module capturing a screen image displayed on the display unit under the control of the scheduler; and a transmission module transmitting the captured screen image to at least one different network device under the control of the scheduler.

According to another aspect of the present invention, there is provided a computer readable recording medium storing a computer readable program for executing a display service method in a network based on a plurality of network devices, the method comprising: capturing a screen image of a first network device based on pre-set schedule information; and transmitting the captured screen image to at least one second network device.

### BRIEF DESCRIPTION OF THE DRAWINGS

The above and other aspects of the present invention will become more apparent by describing in detail exemplary embodiments thereof with reference to the attached drawings in which:

FIG. 1 is a functional block diagram of a network device according to an exemplary embodiment of the present invention;

FIG. 2 is a functional block diagram of a network device according to another exemplary embodiment of the present invention;

FIG. 3 is a functional block diagram of a network device, which outputs a screen image or the screen image and a content file received from the network device illustrated in FIG. 1 or 2, according to an exemplary embodiment of the present invention;

FIG. 4 is a flowchart illustrating a display service method in a display service provider according to an exemplary embodiment of the present invention;

FIG. 5 is a flowchart illustrating a display service method in a display service provider according to another exemplary embodiment of the present invention;

FIG. 6 is a flowchart illustrating a display service method in a display service provider according to another exemplary embodiment of the present invention;

FIG. 7 is a flowchart illustrating a display service method in a display service provider according to another exemplary embodiment of the present invention; and

FIG. 8 is a signaling diagram for explaining a display service method according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

FIG. 1 is a functional block diagram of a network device 100 according to an exemplary embodiment of the present invention. The network device 100 according to an exemplary embodiment of the present invention is connected to a network based on a plurality of network devices. The network device 100 has at least a display function. The network device 100 may further have a function of storing and reproducing a content file. The content file may be at least one of a music content file, a still image content file, a moving picture content file, and a composite content file in which music content and image content are mixed. If the network based on the plurality of network devices is a server-client based network, the network device 100 corresponds to a server.

Referring to FIG. 1, the network device 100 includes a scheduler 101, a display unit 102, a buffer 103; a screen capture module 104, and a transmission module 105.

The scheduler 101 manages a schedule for a display service according to an exemplary embodiment of the present invention based on pre-set schedule information. The schedule information can be previously set using a user command input by a user and/or using stored schedule information. The schedule information may contain information on a screen image to be captured, information on a network device to which a captured screen image is transmitted, and information on a screen image transmission time. Thus, the user command may contain selection information of the screen image to be captured, selection information of the network device to which the captured screen image is transmitted, and selection information of the screen image transmission time. The user command may be defined as a screen image transmission control command.

If a user command contains the selection information of the screen image to be captured, the selection information of the network device to which the captured screen image is transmitted, and the selection information of the screen image transmission time, the scheduler 101 edits a schedule list based on the input user command. The edited schedule list may be defined as illustrated in Table 1.

TABLE 1

| | Network device to which | |
|---|---|---|
| Screen image | screen image is | Screen image |
| transmission time | transmitted | to be captured |
| 2006/7/10/10:00AM | Second network device | Entire screen image |
| 2006/7/10/10:30AM | Third network device | Portion of screen image |
| | | (coordinates |
| | | (0, 0)–(300, 300)) |
| 2006/7/10/11:00AM | Second network device | PowerPoint Image |
| 2006/7/10/11:30AM | Second network device | Entire screen image + |
| | | repeated play of music |
| | | content file (xx.mp3) |
| 2006/7/10/12:00AM | Second and third network | MS-Word Image |
| | devices | |

The schedule list illustrated in Table 1 is an example of schedule information from 10:00 AM Jul. 10, 2006 to 12:00 AM Jul. 10, 2006. Based on Table 1, the network device 100 captures the entire screen image being displayed on the display unit 102 at 10:00 AM Jul. 10, 2006, and transmits the captured screen image to a second network device connected to the network.

The scheduler 101 can manage the edited schedule list by directly setting (or registering) the edited schedule list as schedule information. Alternatively, the scheduler 101 can allow the user to confirm the edited schedule list by displaying the edited schedule list on the display unit 102 in order to set and manage the edited schedule list as schedule information.

If the user wants to use existing schedule information, the scheduler 101 outputs a schedule list edited based on previously set schedule information to the display unit 102. If the user modifies (or edits) the output schedule list, the scheduler 101 can set and manage the modified schedule list as schedule information. Alternatively, the scheduler 101 can allow the user to confirm the modified schedule list by displaying the modified schedule list on the display unit 102 in order to set and manage the modified schedule list as schedule information. During the modification, a portion of the previously set schedule information may be deleted.

The scheduler 101 operates based on a timer to manage the schedule for the display service. Thus, if a time for transmitting a screen image comes based on the pre-set schedule information, the scheduler 101 activates the screen capture module 104 and the transmission module 105.

The display unit 102 displays an image. In particular, the display unit 102 can display a plurality of screen images based on a virtual display environment. The plurality of screen images may include a screen image of a specific program.

The buffer 103 stores information on a screen image displayed on the display unit 102. That is, if a single image is displayed on the display unit 102, the buffer 103 stores information on the single image. If a plurality of screen images are displayed on the display unit 102 based on the virtual display environment, the buffer 103 stores information on the plurality of screen images. The buffer 103 can be realized using a frame buffer. Screen information input to the buffer 103 has a digital format, which can be displayed on the display unit 102. The screen information input to the buffer 103 is information on a screen image reproduced by the network device 100.

The screen capture module 104 captures a screen image displayed on the display unit 102 based on information on the screen image, which is stored in the buffer 103, under the control of the scheduler 101.

For example, if the schedule information is set to transmit a screen image that is displayed prior to a currently displayed screen image, the screen capture module 104 reads screen information corresponding to the screen image that is displayed prior to the screen image currently displayed on the display unit 102 from the buffer 103 and then captures the entire screen image being displayed on the display unit 102.

If the schedule information is set to transmit an image corresponding to coordinates (x, y) from coordinates (0, 0) to coordinates (300, 300) out of a currently displayed screen image, the screen capture module 104 reads screen information of an image corresponding to coordinates (x, y) from coordinates (0, 0) to coordinates (300, 300) out of a screen image currently displayed on the display unit 102 from the buffer 103 and then captures the image within a range of coordinates (x, y) from coordinates (0, 0) to coordinates (300, 300) out of the screen image being displayed on the display unit 102.

If the schedule information is set to transmit a PowerPoint Image, the screen capture module 104 determines whether PowerPoint is being executed in the network device 100. If it is determined that PowerPoint is not being executed in the network device 100, the screen capture module 104 outputs a PowerPoint execution request signal in order to execute PowerPoint in the network device 100. The PowerPoint execution request signal may be input to a control module (not shown) controlling the general function of the network device 100.

As a result, if PowerPoint is executed in the network device 100 and thus a PowerPoint image is displayed on the display unit 102, the screen capture module 104 reads information on the PowerPoint image from the buffer 103 and then captures the PowerPoint image displayed on the display unit 102.

If it is determined that PowerPoint is being executed in the network device 100, the screen capture module 104 can read information on a PowerPoint image from the buffer 103 even though the PowerPoint image is displayed in the virtual display environment. Then, the screen capture module 104 captures the PowerPoint image read from the buffer 103.

The transmission module 105 transmits a screen image captured by the screen capture module 104 to at least one different network device via the network under the control of the scheduler 101. That is, if the schedule information is set to transmit the captured screen image to a specific network device out of network devices connected to the network, the transmission module 105 transmits the captured screen image to a network device registered in the schedule information. If a plurality of network devices are registered in the schedule information, the transmission module 105 transmits the captured screen image to the plurality of network devices. In this case, the transmission module 105 can transmit message information indicating the display service along with information on the captured screen image.

If the schedule information is set to split and transmit a screen image to N network devices, the screen capture module 104 reads screen information from the buffer 103 as if a screen image to be captured is split into N images and respectively captured. The transmission module 105 respectively transmits the N-split and captured images to the N network devices. Thus, an image obtained by uniting the images displayed on the N network devices may be the same as an entire image, a portion of the entire image, or a screen image of a specific program displayed on the display unit 102 of the network device 100.

If the schedule information is set to transmit a screen image to N network devices, the screen capture module 104 captures N screen images, and the transmission module 105 respectively transmits the captured N screen images to the N network devices. The N screen images may be the same images, different images, or images obtained by splitting a screen image into N images. If the N screen images are images obtained by splitting a screen image into N images, each of the N-split images can have an image area overlapping with an adjacent split image.

If the network based on the plurality of network devices is a server-client based network, the different network device corresponds to a client.

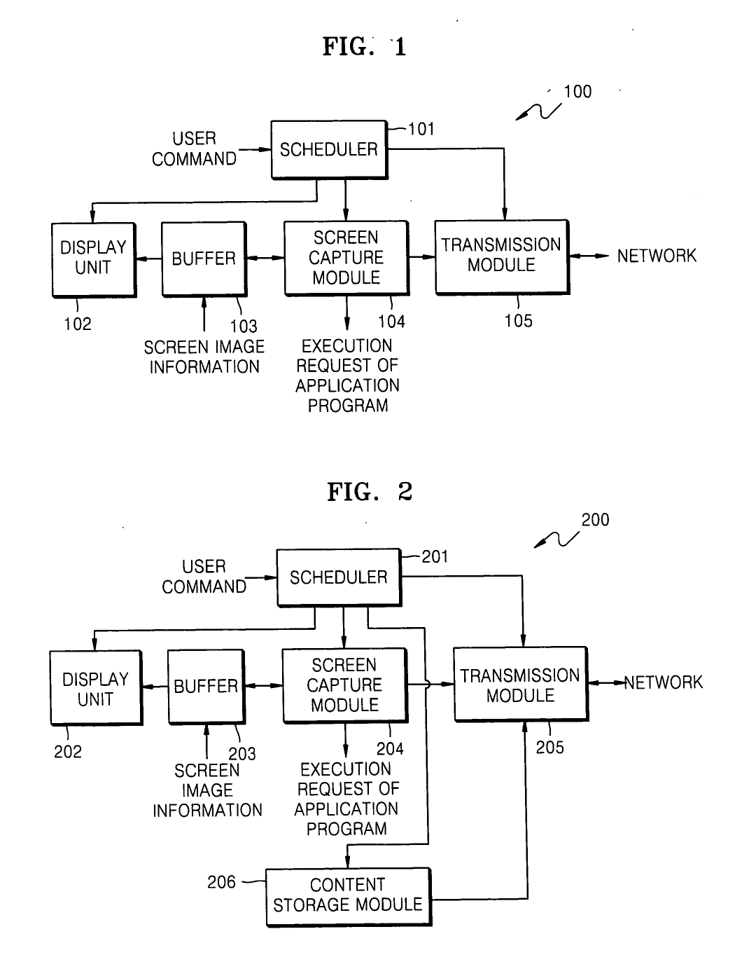

FIG. 2 is a functional block diagram of a network device 200 according to another embodiment of the present invention. The network device 200 according to another embodiment of the present invention performs the same role as the network device 100 illustrated in FIG. 1 in order to provide the display service in the network based on the plurality of network devices. Thus, if the network based on the plurality of network devices is a server-client based network, the network device 200 corresponds to a server.

Referring to FIG. 2, the network device 200 includes a scheduler 201, a display unit 202, a buffer 203, a screen capture module 204, a transmission module 205, and a content storage module 206.

The scheduler 201, the display unit 202, the buffer 203, the screen capture module 204, and the transmission module 205, which are illustrated in FIG. 2, are similar to the scheduler 101, the display unit 102, the buffer 103, the screen capture module 104, and the transmission module 105, which are illustrated in FIG. 1.

The content storage module 206 outputs at least one content file to the transmission module 205 under the control of the scheduler 201. The content storage module 206 can store at least one of a music content file, a still image content file, a moving picture content file, and a composite content file in which music content and image content are mixed.

For example, if schedule information is set as the fourth entry of Table 1, the content storage module 206 transmits the stored music content file (xx.mp3) to the transmission module 205 under the control of the scheduler 201. When the content file is received from the content storage module 206 and information on a captured screen image is received from the screen capture module 204, the transmission module 205 transmits the received content file and the captured screen image to a different network device via the network.

The different network device of FIG. 2 corresponds to a client in a server-client based network.

The network device 100 or 200 illustrated in FIG. 1 or 2 can be modified so that the screen capture module 104 or 204 is included in a control module (not shown) controlling the general function of the network device 100 or 200.

Also, the network device 100 or 200 illustrated in FIG. 1 or 2 can include the above components except the buffer 103 or 203. For example, the network device 100 illustrated in FIG. 1 can include the scheduler 101, the display unit 102, the screen capture module 104, and the transmission module 105 without the buffer 103. In this case, the screen capture module 104 can perform the capturing operation based on a screen image being displayed on the display unit 102, under the control of the scheduler 101. Also, the network device 200 illustrated in FIG. 2 can include the scheduler 201, the display unit 202, the screen capture module 204, and the transmission module 205 without the buffer 203. In this case, the screen capture module 204 can perform the capturing operation based on a screen image being displayed on the display unit 202, under the control of the scheduler 201.

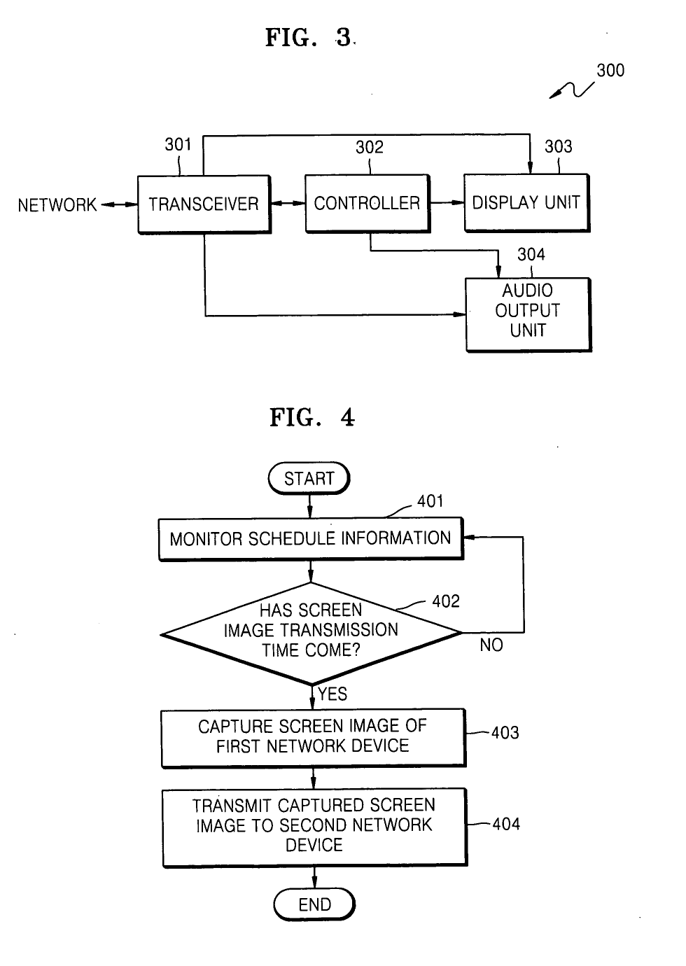

FIG. 3 is a functional block diagram of a network device 300, which outputs a screen image or a content file received from the network device 100 or 200 illustrated in FIG. 1 or 2, according to an exemplary embodiment of the present invention. Thus, the network device 300 corresponds to a client in a server-client based network.

Referring to FIG. 3, the network device 300 includes a transceiver 301, a controller 302, a display unit 303, and an audio output unit 304.

Through the network, the transceiver 301 can receive message information indicating that the currently received information is information for the display service and information on a captured screen image, or receive the message information, information on a captured screen image, and information on at least one content file.

The controller 302 analyzes the message received from the transceiver 301. If it is determined that the information received along with the received message is information for the display service, the controller 302 displays the received information on the display unit 303. Thus, an entire screen image or a portion of the entire screen image displayed on the display unit 303 matches an entire screen image, a portion of the entire screen image, or an image of a specific program displayed on the display unit 102 or 202 illustrated in FIG. 1 or 2.

If the information received along with the received message contains information on a content file, if the received content file is a still image content file or a moving picture content file, and if the received screen image information is information on a portion of an entire screen image, the controller 302 controls the display unit 303 to display the received portion of an entire screen image together with the received still image content or moving picture content. That is, the display unit 303 can display the received still image content or moving picture content as a background image of the received portion of an entire screen image.

If the information received along with the received message contains information on a music content file, the controller 302 displays the received screen information on the display unit 303 and simultaneously outputs the received music content file to the audio output unit 304. Thus, a user of the network device 300 can hear and view a separate content file and a screen image displayed on the network device 100 or 200 illustrated in FIG. 1 or 2. In this case, the network device 100 or 200 illustrated in FIG. 1 or 2 can be modified to simultaneously reproduce and transmit a content file to another network device. Thus, an image and audio output from the network device 100 or 200 illustrated in FIG. 1 or 2 can be the same as an image and audio output from the network device 300 illustrated in FIG. 3.

FIG. 4 is a flowchart illustrating a display service method in a display service provider according to an exemplary embodiment of the present invention. Hereinafter, for convenience of description, a network device in terms of a display service provider is defined as a first network device, and a network device in terms of a display service receiver is defined as a second network device. Thus, the first network device can be formed as illustrated in FIG. 1 or 2, and the second network device can be formed as illustrated in FIG. 3.

Referring to FIG. 4, a first network device monitors pre-set schedule information in operation 401. The schedule information can be previously set as described with the scheduler 101 of FIG. 1. The schedule information is timer-based schedule information, containing information on a screen image to be captured, information on a screen image transmission time, and information on a network device to which a captured screen image is transmitted.

Then, based on the monitoring in operation 401, if it is determined that the screen image transmission time has come in operation 402, the first network device captures a screen image based on the pre-set schedule information in operation 403. That is, if the schedule information is set to transmit an entire screen image that is being currently displayed on the first network device, the first network device captures a currently displayed entire screen image. If the schedule information is set to transmit a portion of an entire screen image that is being currently displayed on the first network device, the first network device captures a portion of a currently displayed entire screen image based on coordinate information contained in the schedule information.

The first network device transmits the captured screen image to at least one second network device in operation 404.

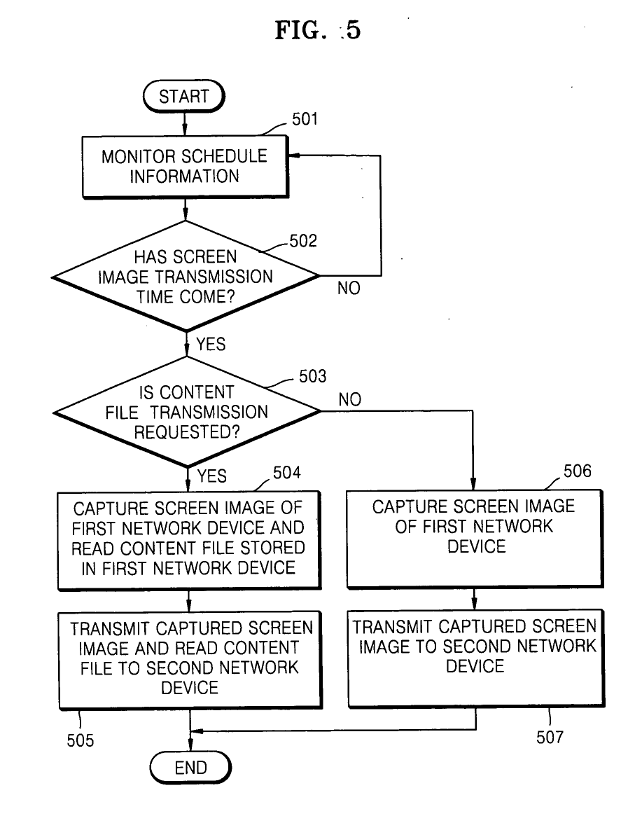

FIG. 5 is a flowchart illustrating a display service method in a display service provider according to another exemplary embodiment of the present invention.

Referring to FIG. 5, a first network device monitors pre-set schedule information in operation 501. Then, based on the monitoring in operation 501, if it is determined that a screen image transmission time has come in operation 502, the first network device determines in operation 503 whether the schedule information contains information for requesting content file transmission.

If it is determined in operation 503 that the schedule information contains the information for requesting content file transmission, the first network device captures a currently displayed screen image and simultaneously reads a transmission-requested content file in operation 504. The transmission-requested content file is stored in the first network device as described with the content storage module 206 of FIG. 2. The captured screen image may be an entire screen image that is being currently displayed on the first network device, or a portion of the entire screen image.

The first network device transmits the captured screen image and the read content file to at least one second network device in operation 505.

If it is determined in operation 503 that the schedule information does not contain information for requesting content file transmission, the first network device captures a currently displayed screen image in operation 506, and transmits the captured screen image to at least one second network device in operation 507.

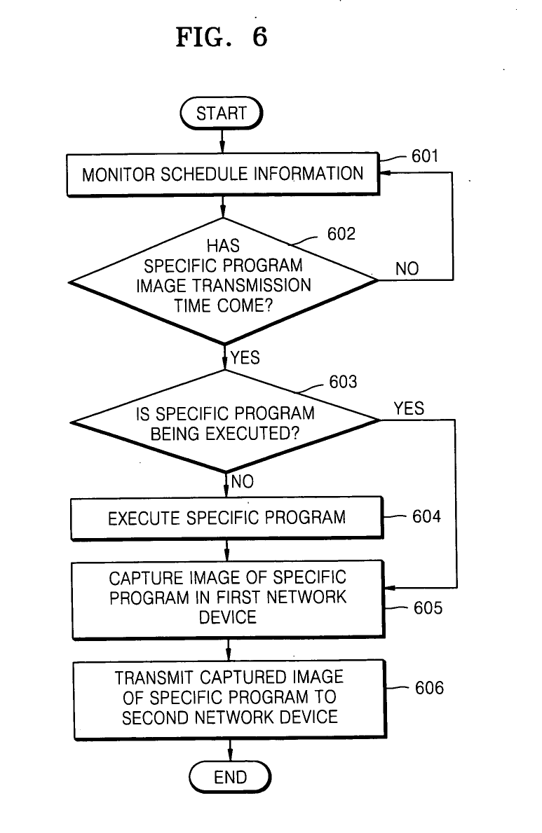

FIG. 6 is a flowchart illustrating a display service method in a display service provider according to another exemplary embodiment of the present invention.

Referring to FIG. 6, a first network device monitors pre-set schedule information in operation 601. Then, based on the monitoring in operation 601, if it is determined that a screen image transmission time has come in operation 602, the first network device determines in operation 603 whether a specific program is being executed. The specific program may be, for example, PowerPoint or MS-Word. If it is determined in operation 603 that the specific program is not being executed, the first network device executes the specific program in operation 604 and captures an image of the specific program in operation 605. If it is determined in operation 603 that the specific program is being executed, the first network device captures an image of the specific program in operation 605.

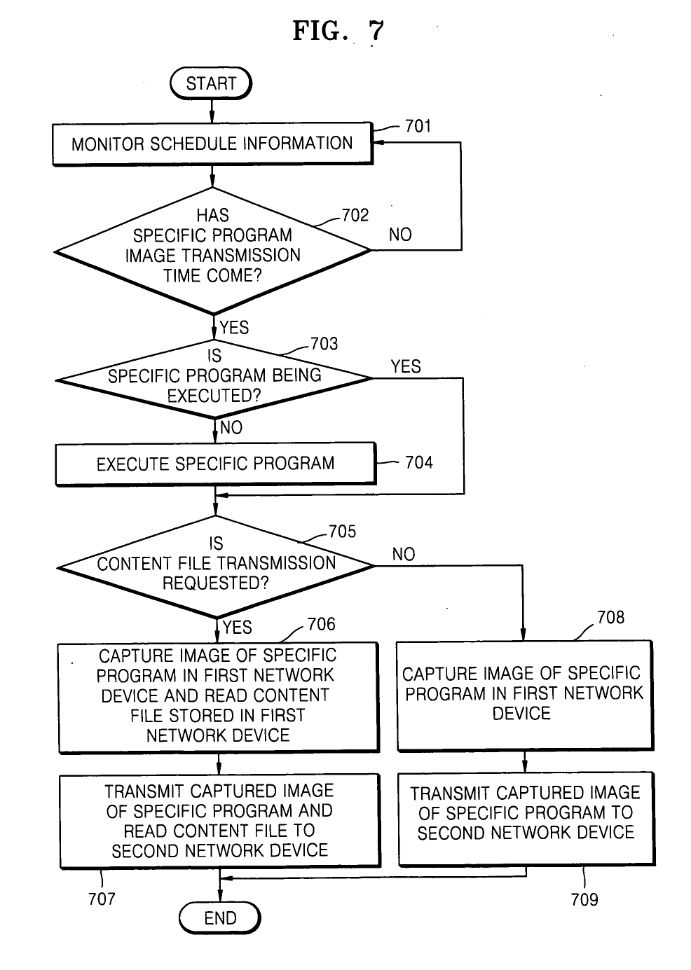

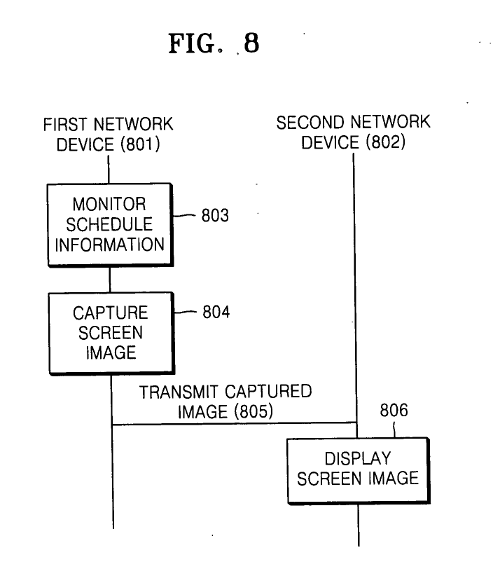

The first network device transmits the captured image of the specific program to at least one second network device in operation 606. FIG. 7 is a flowchart illustrating a display service method in a display service provider according to another embodiment of the present invention.

Referring to FIG. 7, a first network device monitors pre-set schedule information in operation 701. Then, based on the monitoring in operation 701, if it is determined that a screen image transmission time has come in operation 702, the first network device determines in operation 703 whether a specific program is being executed. The specific program may be; for example, PowerPoint or MS-Word. If it is determined in operation 703 that the specific program is not being executed, the first network device executes the specific program in operation 704 and determines in operation 705 whether the schedule information contains information for requesting content file transmission.

If it is determined in operation 705 that the schedule information contains the information for requesting content file transmission, the first network device captures an image of the specific program and simultaneously reads a transmission-requested content file in operation 706. The transmission-requested content file is stored in the first network device as described with the content storage module 206 of FIG. 2.

The first network device transmits the captured image of the specific program and the read content file to at least one second network device in operation 707.

If it is determined in operation 703 that the specific program is being executed, the first network device determines in operation 705 whether the schedule information contains information for requesting content file transmission. If it is determined in operation 705 that the schedule information does not contain information for requesting content file transmission, the first network device captures an image of the specific program in operation 708 and transmits the captured image of the specific program to at least one second network device in operation 709.

FIG. 8 is a signaling diagram for explaining a display service method according to an exemplary embodiment of the present invention. Referring to FIG. 8, a first network device 801 monitors schedule information in operation 803 as described in FIGS. 4 through 7.

Then, based on the monitoring in operation 803, if it is determined that a screen image transmission time has come, the first network device 801 captures a screen image in operation 804. The captured screen image may be an entire screen image that is being currently displayed on the first network device, or a portion of the entire screen image or an image of a specific program executed by the first network device 801.

The first network device 801 transmits the captured screen image to a second network device 802 in operation 805. The second network device 802 displays the received screen image in operation 806.

In the exemplary embodiments of FIGS. 4 through 8, if the schedule information is set to split a screen image that is being displayed on a first network device into N split images and respectively transmit the N split images to N second network devices, in the capturing of the screen image, a screen image to be captured is split into N split images and captured, and in the transmitting of the captured screen image, the captured N split images are respectively transmitted to the N second network devices. In this case, each of the N split images can have an image area overlapping with an adjacent split image.

In the exemplary embodiments of FIGS. 4 through 8, if the schedule information is set to transmit a screen image that is being displayed on a first network device to N second network devices, in the capturing of the screen image, N screen images are captured, and in the transmitting of the captured screen image, the captured N screen images are respectively transmitted to the N second network devices. In this case, the captured N screen images may be the same images, different images, or images obtained by splitting a screen image into N split images.

If the network based on the plurality of network devices is a server-client based network, the first network device 801 corresponds to a server, and the second network device 802 corresponds to a client.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to exemplary embodiments of the present invention, in a network based on a plurality of network devices, a screen image displayed on a certain network device can be captured; automatically transmitted to at least one different network device, and displayed on the at least one different network device based on pre-set schedule information. Thus, even though the different network devices do not have a separate application program, the different network devices can display the captured screen image. That is, the different network devices can display the captured screen image regardless of a format of the captured screen image. Thus, an unmanned automatic display system based on a plurality of network devices can be constructed.

In addition, by transmitting an entire screen image that is being currently displayed on a network device, or a portion of the entire screen image or an image of a specific program executed by the network device to different network devices based on pre-set schedule information, the same screen images or various screen images can be displayed on a plurality of network devices.

In addition, by splitting a screen image displayed on a network device into N images, capturing the N split images and respectively transmitting the captured N split images to different network devices, a wall mount effect using a plurality of network devices can be provided.

In addition, by transmitting at least one content file along with an entire screen image that is being currently displayed on a network device, or a portion of the entire screen image or an image of a specific program executed by the network device to different network devices based on pre-set schedule information, various display services can be provided.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A display service method in a network based on a plurality of network devices, the method comprising:
capturing a screen image of a first network device based on pre-set schedule information; and
transmitting the captured screen image to at least one second network device.

2. The method of claim 1, wherein the captured screen image is one of an entire screen image that is being currently displayed on the first network device, a portion of the entire screen image, and an image of a specific program executed by the first network device.

3. The method of claim 1, further comprising transmitting at least one content file stored in the first network device based on the pre-set schedule information.

4. The method of claim 3, wherein the content file comprises at least one of a music content file, a still image content file, a moving picture content file, and a composite content file in which music content and image content are mixed.

5. The method of claim 2, further comprising executing the specific program if the specific program is not being executed by the first network device when the image of the specific program is transmitted,
wherein the capturing of the screen image comprises capturing the image of the specific program after the specific program is executed.

6. The method of claim 1, wherein if a number of second network devices is N,
the capturing of the screen image comprises capturing N screen images, and
the transmitting of the captured screen image comprises transmitting the captured N screen images to the N second network devices, respectively.

7. The method of claim 1, wherein the pre-set schedule information is timer-based schedule information, containing information on a screen image to be captured, information on a screen image transmission time, and information on a network device to which a captured screen image is transmitted.

8. The method of claim 1, wherein if the network based on the plurality of network devices is a server-client based network, the first network device is a server, and the second network device is a client.

9. A network device capable of providing a display service between network devices, the network device comprising:
a display unit which displays a screen image;
a scheduler which manages a schedule for the display service based on pre-set schedule information;
a screen capture module which captures a screen image displayed on the display unit under the control of the scheduler; and
a transmission module which transmits the captured screen image to at least one different network device under the control of the scheduler.

10. The network device of claim 9, further comprising a buffer which stores information on at least one screen image displayed on the display unit.

11. The network device of claim 9, wherein the screen capture module captures one of an entire screen image that is being currently displayed on the first network device, a portion of the entire screen image, and an image of a specific program executed by the network device.

12. The network device of claim 11, wherein the image of the specific program is displayed in a virtual display environment.

13. The network device of claim 11, wherein if the specific program is not being executed by the network device when the image of the specific program is transmitted,
the screen capture module executes the specific program and then captures the image of the specific program.

14. The network device of claim 9, further comprising a content storage module outputting at least one content file to the transmission module under the control of the scheduler,
wherein the transmission module transmits the at least one content file and the captured screen image to different network devices.

15. The network device of claim 14, wherein the at least one content file comprises at least one of a music content file, a still image content file, a moving picture content file, and a composite content file in which music content and image content are mixed.

16. The network device of claim 9, wherein if the number of different network devices is N,
the screen capture module captures N screen images, and
the transmission module transmits the captured N screen images to the N network devices, respectively.

17. A computer readable recording medium storing a computer readable program for executing a display service method in a network based on a plurality of network devices, the method comprising:
capturing a screen image of a first network device based on pre-set schedule information; and
transmitting the captured screen image to at least one second network device.
